(19) United States
(12) Patent Application Publication
(10) Pub. No.: US 2026/0254108 A1
(43) Pub. Date: Aug. 27, 2026

(54) RADAR SYSTEM WITH TRANSMIT SIGNAL CANCELLATION BETWEEN TRANSMIT AND RECEIVE PHASED ARRAY ANTENNAS

(71) Applicant: MatrixSpace, Inc., Burlington, MA (US)

(72) Inventor: Benjamin O. White, Crystal Lake, IL (US)

(21) Appl. No.: 19/062,513

(22) Filed: Feb. 25, 2025

(51) Int. Cl. H01Q 3/26; H01Q 1/52; H01Q 21/06; H04B 17/12; H04B 17/21

(52) U.S. Cl. CPC H01Q 3/267; H01Q 1/521; H01Q 21/065; H04B 17/12; H04B 17/221

(57) ABSTRACT

A method comprises performing an iterative calibration process in which transmit signals are transmitted via respective different selected subsets of antenna elements of a transmit phased array antenna of a radar system and corresponding amounts of transmit signal energy are monitored in a receive phased array antenna of the radar system to determine impacts of the different selected subsets of antenna elements of the transmit phased array antenna on isolation between the transmit and receive phased array antennas. The method further comprises identifying a particular one of the different selected subsets of the antenna elements of the transmit phased array antenna based at least in part on their relative impacts on the isolation between the transmit and receive phased array antennas, and utilizing the particular identified subset of the antenna elements of the transmit phased array antenna for isolation-enhancing transmit signal cancellation during operation of the radar system.

### TECHNICAL FIELD

Aspects of the present disclosure relate generally to radar systems, and more particularly to radar systems with phased array antennas.

### BACKGROUND

A wide variety of different types of radar systems are known, including, by way of example, various frequency modulated continuous wave (FMCW) radar systems. An FMCW radar system typically transmits and receives at the same time via respective transmit and receive phased array antennas. In such an FMCW radar system, it is important to isolate the transmit phased array antenna from the receive phased array antenna, as they are both operating in the same frequency band at the same time. Conventional approaches are often unable to provide adequate levels of isolation without requiring substantial increases in the size, cost and complexity of the radar system.

### SUMMARY

Illustrative embodiments disclosed herein provide a radar system with transmit signal cancellation between transmit and receive phased array antennas. For example, in some embodiments, transmit signals transmitted by one or more selected antenna elements of a transmit phased array antenna are utilized to cancel transmit signal energy at a receive phased array antenna in a manner that significantly improves the isolation between the transmit and receive phased array antennas. Moreover, such improved isolation can be achieved in some embodiments disclosed herein while also maintaining a minimal distance between the transmit and receive phased array antennas, thereby allowing the radar system to be implemented in a compact and low-cost configuration.

In one embodiment, a method comprises performing an iterative calibration process in which transmit signals are transmitted via respective different selected subsets of antenna elements of a transmit phased array antenna of a radar system and corresponding amounts of transmit signal energy are monitored in a receive phased array antenna of the radar system to determine impacts of the different selected subsets of antenna elements of the transmit phased array antenna on isolation between the transmit and receive phased array antennas. The method further comprises identifying a particular one of the different selected subsets of the antenna elements of the transmit phased array antenna based at least in part on their relative impacts on the isolation between the transmit and receive phased array antennas, and utilizing the particular identified subset of the antenna elements of the transmit phased array antenna for isolation-enhancing transmit signal cancellation during operation of the radar system.

In some embodiments, the transmit and receive phased array antennas comprise respective planar arrays of patch antenna elements, each illustratively comprising a same number and arrangement of antenna elements, although other types and arrangements of antenna elements can be used.

The different selected subsets of antenna elements of the transmit phased array antenna in some embodiments each comprise one or more of the antenna elements. For example, one or more of the different selected subsets may illustratively each comprise only a single antenna element of the transmit phased array antenna. Other groupings of antenna elements into selected subsets may be used in the iterative calibration process.

In some embodiments, utilizing the particular identified subset of the antenna elements of the transmit phased array antenna for isolation-enhancing signal cancellation during operation of the radar system illustratively comprises transmitting a transmit signal via the particular identified subset of the antenna elements at particular phase and amplitude values determined as part of the iterative calibration process.

The particular phase and amplitude values in some embodiments illustratively comprise phase and amplitude values identified by adjusting the isolation between the transmit and receive phased array antennas during the iterative calibration process until a receive signal power threshold is met.

Additionally or alternatively, in some embodiments, the transmit and receive phased array antennas are separated from one another by at least one absorber configured to further enhance isolation between the transmit and receive phased array antennas. For example, some embodiments utilize a combination of an external absorber and an internal absorber.

In some embodiments, the iterative calibration process is configured to iterate in an outer loop over a plurality of beam steering directions of the transmit phased array antenna and to iterate in an inner loop over the different selected subsets of the antenna elements of the transmit phased array antenna for each of the plurality of beam steering directions of the outer loop.

For a given one of the iterations of the inner loop, at least one of phase and amplitude values of the transmit signal transmitted by a corresponding one of the different selected subsets of the antenna elements are incrementally varied as corresponding amounts of transmit signal energy are monitored in the receive phased array antenna of the radar system.

In some embodiments, the above-noted identifying a particular one of the different selected subsets of the antenna elements, and utilizing the particular identified subset of the antenna elements of the transmit phased array antenna for isolation-enhancing transmit signal cancellation are separately performed for each of one or more of the plurality of beam steering directions iterated in the outer loop.

The iterative calibration process in some embodiments is performed at least one of in conjunction with an initialization of the radar system, at each of a plurality of different start-ups of the radar system and/or as a substantially continuous background process.

It is to be appreciated that the foregoing arrangements are only examples, including examples of potential applications of the disclosed techniques, and numerous alternative arrangements are possible.

These and other illustrative embodiments include but are not limited to systems, methods, apparatus, processing devices, integrated circuits, and computer program products comprising processor-readable storage media having software program code embodied therein.

### BRIEF DESCRIPTION OF THE FIGURES

FIG. 1 is a block diagram of an example radar system with transmit signal cancellation between transmit and receive phased array antennas in an illustrative embodiment.

FIG. 2 shows a portion of a radar system including transmit and receive phased array antennas in an illustrative embodiment.

FIG. 3 shows an example placement of internal and external absorbers relative to a radome of a radar system in an illustrative embodiment.

FIG. 4 is a flow diagram of an example iterative calibration process implemented in a radar system in an illustrative embodiment.

FIG. 5 shows example transmit and receive antenna beams generated in an illustrative embodiment.

### DETAILED DESCRIPTION

Illustrative embodiments include radar systems comprising transmit and receive phased array antennas. Such radar systems in some embodiments can be implemented as at least a portion of an information processing system that comprises one or more computers, servers or other processing devices. For example, a given radar system of the type disclosed herein can be integrated into an information processing system that includes one or more additional radar systems and/or other types of sensor systems of potentially different sensor modalities, such as optical, infrared (IR), thermal, etc. As a more particular example, a radar system as disclosed herein can be deployed on a drone or on another type of aerial or terrestrial vehicle, and in numerous other use cases without limitation. A number of examples of illustrative radar systems and corresponding signal processing operations will be described in detail herein. It should be understood, however, that the techniques disclosed herein are more generally applicable to a wide variety of other types of radar systems and associated processing devices and other components. Accordingly, the term “radar system” as used herein is intended to be broadly construed so as to encompass these and other arrangements.

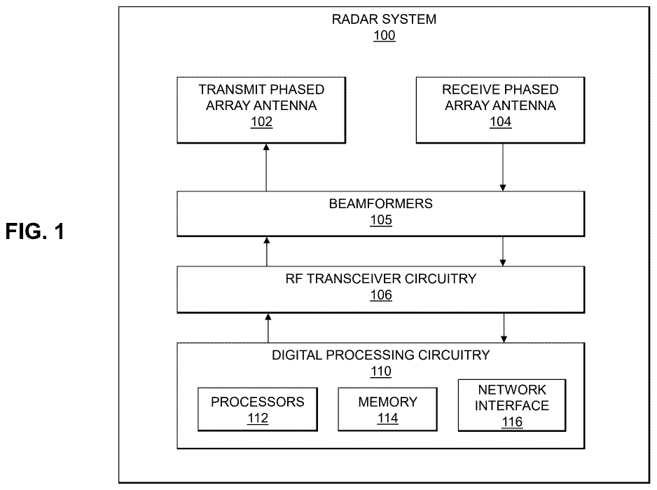

FIG. 1 shows an example radar system 100 in an illustrative embodiment. The radar system 100 comprises a transmit phased array antenna 102 and a receive phased array antenna 104. The transmit phased array antenna 102 and the receive phased array antenna 104 in some embodiments are implemented as respective planar arrays of patch antenna elements, although other types and arrangements of phased array antennas and their associated antenna elements can be used in other embodiments. As one example, each of the transmit phased array antenna 102 and the receive phased array antenna 104 in some embodiments includes substantially the same number, type and arrangement of antenna elements.

In some embodiments, the receive phased array antenna 104 may comprise what is referred to herein as a “split” receive phased array antenna, including a plurality of separate sub-arrays, illustratively at least first and second sub-arrays of different antenna elements. It is to be appreciated that the term “split” as used in this context herein is intended to be broadly construed, and should not be viewed as requiring separation into physically-separable components. More generally, the term is intended to encompass any receive phased array antenna in which respective different subsets of the antenna elements, each considered a separate sub-array, are coupled to respective different receive signals paths for processing of received signals. In other embodiments, the receive phased array antenna 104 may comprise more than two separate sub-arrays, instead of just first and second sub-arrays. It should also be appreciated that other embodiments do not require use of separate sub-arrays for the receive phased array antenna 104.

The transmit phased array antenna 102 and the receive phased array antenna 104 respectively transmit and receive at substantially the same time, in what is generally referred to herein as a type of “monopulse” arrangement, although, as indicated previously, use of pulsed signals is not required in such arrangements.

The radar system 100 in some embodiments is implemented as a frequency modulated continuous wave (FMCW) radar system operating in a millimeter wave frequency band. For example, the radar system 100 in some embodiments is configured to operate with a center frequency f_{c} of about 24.45 to 24.65 GHz modulated by a 40 MHz chirp signal, although numerous other operating frequencies, modulation types and other parameters can be used in other embodiments.

An FMCW radar system such as radar system 100 transmits and receives at the same time via its respective transmit phased array antenna 102 and receive phased array antenna 104. Accordingly, it is particularly important to isolate the transmit phased array antenna 102 from the receive phased array antenna 104, as they are both operating in the same frequency band at the same time.

Conventional approaches generally fail to provide a sufficient level of isolation between transmit and receive phased array antennas in an FMCW radar system. Illustrative embodiments herein overcome these and other drawbacks of conventional approaches, by providing technical solutions that can achieve levels of isolation on the order of 110 decibels (dB) at about 24.45 to 24.65 GHz. Moreover, such improved isolation can be achieved in some embodiments disclosed herein while also maintaining a minimal distance between the transmit and receive phased array antennas, thereby allowing the radar system to be implemented in a compact and low-cost configuration.

These and other advantages of illustrative embodiments disclosed herein are achieved at least in part through the use of an iterative calibration process and associated internal and/or external absorber arrangements, as will be described in more detail below.

Referring again to FIG. 1, the radar system 100 further comprises a plurality of beamformers 105, illustratively including a transmit beamformer for driving the transmit phased array antenna 102 and at least one receive beamformer for driving the receive phased array antenna 104. In embodiments in which there are multiple receive signal paths associated with different sub-arrays of the receive phased array antenna 104, there is illustratively a different receive beamformer in the beamformers 105 for each such sub-array. Each such transmit or receive beamformer generally includes a separate set of adjustable gain and phase elements for each antenna element of the transmit or receive phased array antenna, for adjusting corresponding amplitude and phase values for respective transmit or receive signals applied to those antenna elements in order to steer the corresponding antenna beam. For example, the antenna beams may be periodically scanned across a designated field of view and/or may be controlled to track one or more detected targets using closed-loop tracking mechanisms. In some embodiments, location information obtained from a global positioning system (GPS) receiver, orientation information obtained from an internal measurement unit (IMU) and/or various other types of information accessible to the radar system 100, can be used to at least partially control beam steering directions of the transmit and receive phased array antennas. The beamformers 105 in some embodiments are implemented utilizing one or more beamformer integrated circuits.

The beamformers 105 are coupled to RF transceiver circuitry 106 and digital processing circuitry 110 as shown. The RF transceiver circuitry 106 in some embodiments comprises one or more transceiver RF integrated circuits (RFICs) for processing transmit and receive signals in the radar system 100. The one or more transceiver RFICs may comprise, for example, software-defined radio (SDR) RFICs. The digital processing circuitry 110 includes one or more processors 112, memory 114 and a network interface 116.

Software stored in the memory 114 and executed by the one or more processors 112 is illustratively utilized to control various aspects of the operation of the radar system 100, such as generating transmit signals for transmission via the transmit phased array antenna 102, processing receive signals received via the receive phased array antenna 104, and electronically steering the corresponding antenna beams. Outputs generated by the radar system 100 may be transmitted over one or more networks to one or more other system devices, such as a display terminal, via the network interface 116. For example, such outputs may be combined in a processing platform of an associated information processing system with outputs of one or more other radar systems and/or sensor outputs of other sensor modalities.

The radar system 100 is illustratively configured to generate a transmit signal, to transmit the transmit signal via the transmit phased array antenna 102, and to receive at least one receive signal via the receive phased array antenna 104. For example, in an embodiment with a split receive phased array antenna arrangement with first and second sub-arrays, the receive phased array antenna 104 may comprise a square array of antenna elements and the first and second sub-arrays may comprise respective first and second halves of the square array of antenna elements.

As a more particular example, the receive phased array antenna 104 may comprise a four-by-four array of antenna elements, with the first and second sub-arrays comprising respective two-by-four sub-arrays of the four-by-four array.

The transmit phased array antenna 102 in some embodiments has the same number and type of antenna elements as the receive phased array antenna 104, but without separate sub-arrays. For example, in an embodiment in which the receive phased array antenna 104 comprises a four-by-four array of antenna elements, the transmit phased array antenna 102 may similarly comprise a four-by-four array of antenna elements.

Again, numerous other arrangements are possible. For example, the receive phased array antenna 104 can be treated as a single array, without separate receive signal paths for different sub-arrays of antenna elements.

In some embodiments in which the receive phased array antenna 104 comprises first and second sub-arrays, the first sub-array is electronically steered utilizing a first type of squinting and the second sub-array is electronically steered using a second type of squinting different than the first type of squinting. Terms such as “squint” and “squinting” as used herein are intended to be broadly construed so as to encompass, for example, deliberately introducing an amount of angular directional offset of the antenna beam in a particular pointing direction relative to a boresight of the phased array antenna, where the boresight corresponds to 0° azimuth and 0° elevation.

For example, in some embodiments, the first type of squinting comprises a first amount of squinting in one of an upward elevation direction and a downward elevation direction and the second type of squinting comprises a second amount of squinting in the other of the upward elevation direction and the downward elevation direction. As a more particular example, the first sub-array may be squinted in an upward elevation direction (e.g., +10° in elevation) and the second sub-array may be squinted in a downward elevation direction (e.g., −10° in elevation), or vice versa. Accordingly, in some embodiments, the first and second amounts of squinting of the respective first and second sub-arrays are substantially equivalent to one another (e.g., both are 10°), but are in respective different directions (e.g., upward and downward in elevation).

In some embodiments in which the squinting of the first and second sub-arrays is in elevation (e.g., upward and downward respectively in elevation), there is illustratively no squinting introduced in azimuth. In other words, the antenna beams of the first and second sub-arrays point in the same azimuth direction.

Other squinting arrangements can be implemented in other embodiments. For example, one of the first and second sub-arrays can be configured with a non-zero amount of squint in a particular direction, and the other of the first and second sub-arrays can be configured with a substantially zero amount of squint. The term “amount of squint” as applied to either one of the two sub-arrays of the receive phased array antenna 104 as used herein is therefore intended to be broadly construed so as to encompass, for example, a zero or substantially zero amount of squint introduced for one of the two sub-arrays, while a non-zero amount of squint is introduced for the other one of the two sub-arrays, so as to provide a differential squinting between the sub-arrays. Again, numerous other arrangements are possible for introducing a differential squint between multiple sub-arrays of a receive phased array antenna as disclosed herein.

Also, as indicated previously, use of multiple sub-arrays is not required in a receive phased array antenna in illustrative embodiments herein, and the receive phased array antenna can instead be treated as a single array.

The radar system 100 is configured to generate the above-noted transmit signal from a corresponding digital transmit signal in a transmit signal path of the radar system 100. The transmit signal path illustratively comprises a serial arrangement of at least a transmit digital-to-analog converter (DAC), a transmit mixer, and a transmit beamformer coupled to the transmit phased array antenna 102. The transmit DAC and transmit mixer are illustratively part of a transmit path portion of the RF transceiver circuitry 106, and the transmit beamformer is implemented as one of the beamformers 105. The digital transmit signal is illustratively generated using the one or more processors 112 of the digital processing circuitry 110.

The radar system 100 is further configured to process the above-noted one or more receive signals. For example, assuming that the receive phased array antenna comprises first and second sub-arrays, receive signals from the respective first and second sub-arrays are processed through respective first and second receive signal paths to generate respective first and second digital receive signals. Each of the first and second receive signal paths illustratively comprises a serial arrangement of at least a receive beamformer coupled to the corresponding first or second sub-array of the receive phased array antenna 104, a receive mixer and a receive analog-to-digital converter (ADC). The receive mixer and the receiver DAC are illustratively part of a receive path portion of the RF transceiver circuitry 106, and the receive beamformer is implemented as one of the beamformers 105. In some embodiments, processing the first and second receive signals through the respective first and second receive signal paths to generate the respective first and second digital receive signals comprises demodulating the first and second receive signals in the respective first and second receive signal paths, illustratively using the RF transceiver circuitry 106. The first and second digital receive signals are illustratively processed using the one or more processors 112 of the digital processing circuitry 110.

The radar system 100 is further configured to compute respective first and second sets of range-Doppler information for the respective first and second digital receive signals, and to determine range and velocity for a target based at least in part on a combination of at least portions of the first and second sets of range-Doppler information. These operations are illustratively performed in the digital processing circuitry 110 utilizing the one or more processors 112. The first and second sets of range-Doppler information in some embodiments comprise respective first and second range-Doppler maps, although other types and arrangements of range-Doppler information can be used. The term “range-Doppler information” as used herein is therefore intended to be broadly construed, so as to encompass, for example, one or more data structures that capture such information as it is obtained within the radar system 100. Also, the term “target” as used herein is intended to be broadly construed, and should not be viewed as requiring a particular detection arrangement, such as detection to a particular level of resolution or detection accuracy.

In some embodiments, the target is detected at least in part by summing the first and second sets of range-Doppler information, and identifying a signal of interest in the summed first and second sets of range-Doppler information utilizing a constant false alarm rate (CFAR) algorithm.

Other target detection techniques can be used in other embodiments.

The radar system 100 is also configured to compute an azimuth angle for the target based at least in part on phase information of the respective first and second digital receive signals, and to compute an elevation angle for the target based at least in part on magnitude information of the respective first and second digital receive signals. Such information collectively provides an angle-of-arrival (AOA) for the target in two orthogonal directions. The corresponding azimuth and elevation angle computation operations are also illustratively performed in the digital processing circuitry 110 utilizing the one or more processors 112.

Computing an azimuth angle for the target based at least in part on phase information of the respective first and second digital receive signals illustratively comprises computing the azimuth angle based at least in part on a phase difference between the first and second digital receive signals. For example, an azimuth angle θ_{az} can be computed utilizing a phase difference in accordance with the following relationship:

$${θ}_{a z} ∝ \frac{{ϕ}_{R X 1} - {ϕ}_{R X 2}}{{ϕ}_{R X 1} + {ϕ}_{R X 2}}$$

where φ_{RX1} denotes the phase of the first digital receive signal, φ_{RX2} denotes the phase of the second digital receive signal, and the symbol ∝ denotes “is proportional to.” The actual computation of the azimuth angle in some embodiments is implemented as a complex function with non-linearities and non-idealities that are compensated through characterization and calibration processes and/or lookup tables.

For example, in some embodiments, an angle θ from the target is illustratively related to the phase difference Δφ between the phases φ_{RX1} and θ_{RX2} of the respective first and second digital receive signals as follows:

$$Δϕ = ( \frac{2 π}{λ} ) d sin ( θ )$$

$$θ = a sin ( \frac{λ Δ ϕ}{2 π d} )$$

where λ denotes signal wavelength, d denotes a distance between respective center points of the first and second sub-arrays, corresponding to their respective boresights, and a sin(·) denotes the arcsine function.

Computing an elevation angle for the target based at least in part on magnitude information of the respective first and second digital receive signals illustratively comprises computing the elevation angle based at least in part on an amplitude difference between the first and second digital receive signals.

For example, an elevation angle θₑₗ can be computed utilizing an amplitude difference in accordance with the following relationship:

$${θ}_{e l} ∝ \vert \frac{{A}_{R X 1} - {A}_{R X 2}}{{A}_{R X 1} + {A}_{R X 2}} \vert$$

where A_{RX1} denotes the amplitude of the first digital receive signal and A_{RX2} denotes the amplitude of the second digital receive signal. Like the azimuth angle computation, the actual computation of the elevation angle in some embodiments is implemented as a complex function with non-linearities and non-idealities that are compensated through characterization and calibration processes and/or lookup tables.

These example arrangements advantageously provide a finer AOA resolution than would otherwise be possible, illustratively an AOA resolution of approximately 3° to 5°, utilizing only two receive signal paths, while also reducing radar system cost, size and power consumption. Illustrative embodiments disclosed herein therefore utilize a combination of phase and amplitude information to achieve a finer AOA resolution in two orthogonal directions than would otherwise be possible, and using only two receive signal paths.

Other techniques can be used to compute azimuth and elevation angles for a detected target based at least in part on phase and amplitude of the first and second digital receive signals in other embodiments.

The radar system 100 is additionally configured to output at least a subset of the range, velocity, azimuth angle and elevation angle for the target. For example, such values or subsets thereof can be output by one portion of the digital processing circuitry 110 to another portion of the digital processing circuitry 110 for further processing. Additionally or alternatively, such values generated in the radar system 100 can be output from a given one of the processors 112 for storage in the memory 114 and/or for delivery via the network interface 116 to an external system or component. The external system or component may comprise, for example, a processing platform configured to fuse outputs of the radar system 100 with outputs of other radar systems and/or other sensors utilizing other sensor modalities. As another example, the external system or component may comprise an automated tracking system and/or a display for presenting the values to a user. At least portions of these and other systems or components can be at least partially implemented within the radar system 100 in other embodiments. As indicated previously, the term “radar system” as used herein is intended to be broadly construed.

An example configuration of the radar system 100 utilizing a split receive phased array antenna will now be described.

In this example, the radar system 100 includes two 16-element phased array antennas, one for transmit and one for receive. Such an arrangement in an FMCW radar system illustratively provides a fairly broad beamwidth, for example, a beamwidth of approximately 28° by 28°. However, utilization of the techniques disclosed herein, including a split receive phased array antenna and associated signal processing, can provide a finer resolution for AOA while also reducing radar system cost, size and power consumption. More particularly, as previously described, some embodiments utilize a combination of phase and amplitude information to achieve finer AOA resolution in two orthogonal directions using only two receive signal paths. For example, some embodiments are configured to provide improved AOA resolution of approximately 3° to 5°, although it is to be appreciated that other AOA resolution values could be provided in other embodiments.

As indicated above, in the present example, the 16-element receive phased array antenna is divided into the two 8-element sub-arrays, each associated with a different receive signal path. The first receive signal path for processing a first receive signal from the first sub-array includes a first receive beamformer and corresponding first receive signal path portions through a transceiver RFIC and a field-programmable gate array (FPGA) to a processor. Similarly, the second receive signal path for processing a second receive signal from the second sub-array includes a second receive beamformer and corresponding second receive signal path portions through the transceiver RFIC and the FPGA to the processor. The radar system further includes software executing on the processor. The processor generates output data at least portions of which may be presented on a display.

In this embodiment, the antenna beams of the first and second sub-arrays are electronically steered utilizing respective different first and second types of squinting. More particularly, the sub-array beams are respectively squinted up and down relative to one another (e.g., by +10° and −10° respectively) in the elevation direction, but the two sub-array beams point in the same azimuth direction.

Also, phase comparison between first and second digital receive signals is used to determine the azimuth angle providing the AOA in the azimuth direction, while amplitude comparison between the first and second digital receive signals is simultaneously used to determine the elevation angle providing the AOA in the elevation direction.

In this embodiment, signals generated in the receive side of the radar system 100 illustratively comprise respective azimuth and elevation error voltages that vary monotonically with the AOA of the target with respect to the center of the antenna beam as shown. Given these error voltages, if the corresponding error functions are known, the AOA relative to beam center can be estimated in azimuth and elevation directions. The radar system 100 illustratively utilizes two such error functions for the two orthogonal beam pointing directions to determine the AOA of the target.

For each of the first and second receive signal paths, the radar system 100 performs functions such as downconversion and demodulation and converts the resulting signal to digital form in an ADC. These operations are illustratively performed in the transceiver RFIC for each of the first and second receive signal paths. The resulting first and second digital receive signals are then further processed in the manner previously described herein to generate the phase information and the amplitude information and to compute therefrom the respective azimuth angle and elevation angle of the AOA, with such processing illustratively being performed in the FPGA and/or the processor.

In this example, the radar system 100 further comprises transmit and receive beamformers, which illustratively include adjustable gain and phase blocks, and may be part of one or more beamformer integrated circuits.

In the transmit signal path, a digital transmit signal is generated using the FPGA under the control of the processor and delivered to respective in-phase (I) and quadrature (Q) inputs of the RFIC. Each of the I and Q components of the transmit signal is converted from digital to analog in a DAC, filtered in a low-pass filter, and modulated onto a carrier signal via a mixer. The resulting signals are then combined and applied to a variable gain amplifier. A local oscillator (LO) signal generated by an LO coupled to a phase-locked loop (PLL) drives one input of a transmit upconverter mixer that receives the combined and amplified transmit signal at its other input. The output of the transmit upconverter mixer drives an adjustable gain and phase block of a transmit beamformer that imparts a desired gain and phase to the transmit signal under the control of a gain/phase control signal from the processor, individually for corresponding signal instances transmitted by respective ones of the 16 different antenna elements of the transmit phased array antenna 102.

In the first receive signal path, a first receive signal from the first sub-array of the receive phased array antenna 104 is applied to a first receive beamformer. The first receive beamformer imparts a desired gain and phase to the first receive signal in an adjustable gain and phase block under the control of a gain/phase control signal from the processor, individually for corresponding signal instances received by respective ones of the 8 different antenna elements of the first sub-array of the receive phased array antenna 104. The resulting first receive signal drives one input of a first receive downconverter mixer which receives at its other input the LO signal from the LO. The resulting downconverted first receive signal is subject to variable gain amplification and demodulation, with the resulting I and Q components each being filtered in a low-pass filter, converted from analog to digital in an ADC, and applied to the FPGA as respective I and Q components of a first digital receive signal.

In the second receive signal path, a second receive signal from the second sub-array of the receive phased array antenna 104 is applied to a second receive beamformer. The second receive beamformer imparts a desired gain and phase to the second receive signal in an adjustable gain and phase block under the control of a gain/phase control signal from the processor, individually for corresponding signal instances received by respective ones of the 8 different antenna elements of the second sub-array of the receive phased array antenna 104. The resulting second receive signal drives one input of a second receive downconverter mixer which receives at its other input the LO signal from the LO. The resulting downconverted second receive signal is subject to variable gain amplification and demodulation, with the resulting I and Q components each being filtered in a low-pass filter, converted from analog to digital in an ADC, and applied to the FPGA as respective I and Q components of a second digital receive signal.

The first and second digital receive signals received over the respective first and second receive signals paths are then subject to further processing in the FPGA and processor in order to determine range and velocity for a target, as well as azimuth angle and elevation angle for an AOA of the target, as described previously.

Examples of additional processing operations that are implemented in the radar system 100 in illustrative embodiments include various types of calibration operations relating to at least one of the first and second digital receive signals. Such calibration operations can include, for example, applying one or more calibration corrections digitally to at least one of the first and second digital receive signals in the digital processing circuitry 110, before computing the first and second sets of range-Doppler information for the respective first and second digital receive signals.

Additionally or alternatively, such calibration operations can include generating one or more calibration coefficients at least in part as a function of a beam pointing angle and/or equalizing or otherwise normalizing at least respective portions of the first receive signal path and the second receive signal path, where the term “normalizing” is broadly used herein to encompass equalizing and other arrangements. For example, equalizing or otherwise normalizing at least respective portions of the first and second receive signal paths in some embodiments can comprise performing complex normalization to normalize gain and phase of the first and second receive signal paths.

Accordingly, in some embodiments, calibrations performed by the digital processing circuitry 110 can include, for example, performing corrections on at least portions of one or both receive signal paths before and/or after computing the range-Doppler information, performing corrections depending on where the antenna beam is pointing, correcting phase and/or amplitude of one or both of the receive signals, as well as performing additional or alternative calibration operations.

As indicated previously, some embodiments disclosed herein are configured to achieve improved isolation between the transmit phased array antenna 102 and the receive phased array antenna 104 at least in part through the use of an iterative calibration process, as will now be described in more detail.

For example, the radar system 100 in some embodiments is configured to implement an iterative calibration process in which transmit signals are transmitted via respective different selected subsets of antenna elements of the transmit phased array antenna 102 of the radar system 100 and corresponding amounts of transmit signal energy are monitored in the receive phased array antenna 104 of the radar system 100 to determine impacts of the different selected subsets of antenna elements of the transmit phased array antenna 102 on isolation between the transmit and receive phased array antennas 102 and 104.

The radar system 100 in such an embodiment is further configured to identify a particular one of the different selected subsets of the antenna elements of the transmit phased array antenna 102 based at least in part on their relative impacts on the isolation between the transmit and receive phased array antennas 102 and 104, and to utilize the particular identified subset of the antenna elements of the transmit phased array antenna 102 for isolation-enhancing transmit signal cancellation during operation of the radar system 100. The term “operation” of the radar system in this context is intended to be broadly construed, so as to encompass, for example, a normal operating mode of the radar system in which targets are detected and/or tracked, as opposed to a calibration mode.

One or more of the different selected subsets in some embodiments each comprise only a single antenna element of the transmit phased array antenna 102. Thus, for example, a single one of 16 antenna elements in a four-by-four transmit antenna array may be identified in the iterative calibration process for use in isolation-enhancing signal cancellation. The different selected subsets may comprise different numbers of antenna elements of the transmit phased array antenna 102 in other embodiments. For example, two or more antenna elements may be identified in the iterative calibration process for use in isolation-enhancing signal calibration. The term “subset” of antenna elements as used herein is intended to be broadly construed, and may comprise one or more antenna elements of a transmit antenna array.

In some embodiments, utilizing the particular identified subset of the antenna elements of the transmit phased array antenna 102 for isolation-enhancing signal cancellation during operation of the radar system 100 comprises transmitting a transmit signal via the particular identified subset of the antenna elements at particular phase and amplitude values determined as part of the iterative calibration process. For example, the particular phase and amplitude values may illustratively comprise phase and amplitude values identified by adjusting the isolation between the transmit and receive phased array antennas 102 and 104 during the iterative calibration process until a receive signal power threshold is met.

The iterative calibration process in some embodiments includes a plurality of distinct loops, including by way of example an outer loop and one or more inner loops. For example, the iterative calibration process may be configured to iterate in an outer loop over a plurality of beam steering directions of the transmit phased array antenna 102 and to iterate in an inner loop over the different selected subsets of the antenna elements of the transmit phased array antenna 102 for each of the plurality of beam steering directions of the outer loop.

In such an arrangement, for a given one of the iterations of the inner loop, at least one of phase and amplitude values of the transmit signal transmitted by a corresponding one of the different selected subsets of the antenna elements are incrementally varied as corresponding amounts of transmit signal energy are monitored in the receive phased array antenna of the radar system.

Additionally or alternatively, the above-noted identifying and utilizing are separately performed for each of one or more of the plurality of beam steering directions iterated in the outer loop.

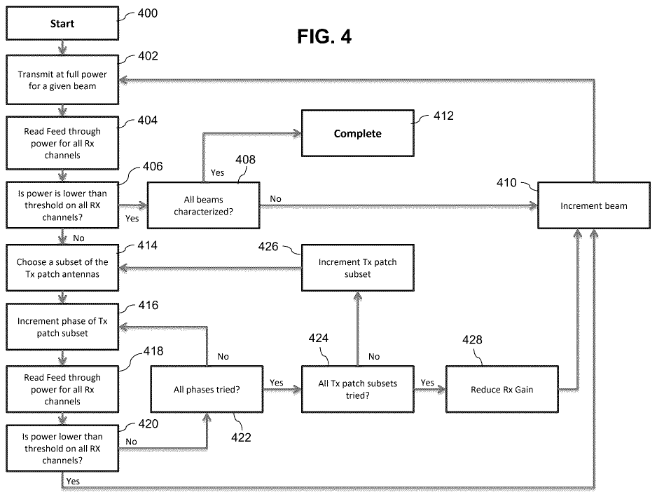

A more detailed example of an iterative calibration process with outer and inner loops will be described below in conjunction with the flow diagram of FIG. 4.

An iterative calibration process of the type disclosed herein can be performed at various points in the operation of the radar system 100. For example, the iterative calibration process may be performed at least one of in conjunction with an initialization of the radar system 100, at each of a plurality of different start-ups of the radar system 100, as a substantially continuous background process and/or under other specified conditions.

Again, it is to be appreciated that the particular arrangements of FIG. 1 are presented by way of example only, to illustrate possible implementations of an example radar system as disclosed herein, and should not be viewed as limiting in any way.

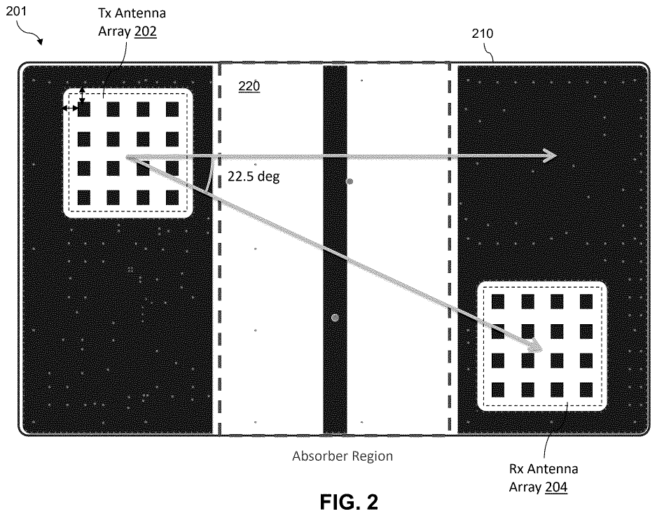

Additional details regarding illustrative embodiments will now be described in conjunction with FIGS. 2 through 5.

As indicated above, each of the transmit phased array antenna 102 and the receive phased array antenna 104 in some embodiments includes substantially the same number, type and arrangement of antenna elements.

FIG. 2 shows an example antenna arrangement of this type. In this embodiment, a portion 201 of a radar system includes a transmit phased array antenna implemented as Tx antenna array 202 and a receive phased array antenna implemented as Rx antenna array 204. The radar system in this embodiment is assumed to be implemented as an FMCW radar system operating in a millimeter wave frequency band, although other modulation types and frequency ranges can be used in other embodiments. As indicated previously, the FMCW radar system transmits and receives at the same time, and so it is particularly important to isolate the Tx antenna array 202 from the Rx antenna array 204, as they are both operating in the same frequency band at the same time. In some embodiments, levels of isolation on the order of 110 dB at about 24.45 to 24.65 GHz can be achieved. Moreover, such improved isolation can be achieved in some embodiments disclosed herein while also maintaining a minimal distance between the transmit and receive phased array antennas, thereby allowing the radar system to be implemented in a compact and low-cost configuration.

In this embodiment, the Tx antenna array 202 and the Rx antenna array 204 comprise respective planar arrays of patch antenna elements, with each of the Tx and Rx antenna arrays 202 and 204 comprising a same number and arrangement of antenna elements. More particularly, each of the Tx and Rx antenna arrays 202 and 204 in this embodiment comprises a four-by-four array of 16 antenna elements, arranged as shown in the figure. It is to be appreciated that this is only an example, and numerous other arrangements of antenna elements can be used in Tx and Rx antenna arrays in other embodiments.

The Tx and Rx antenna arrays 202 and 204 in the present embodiment are separated from one another by at least one absorber configured to further enhance isolation between the Tx and Rx antenna arrays 202 and 204.

More particularly, as illustrated in the figure, the Tx and Rx antenna arrays 202 and 204 comprise respective first and second sets of patch antenna elements with the first and second sets arranged in opposing corners of a printed circuit board 210. The first and second sets of patch antenna elements are formed on a same surface of the printed circuit board 210, and each of the first and second sets is surrounded by a corresponding one of first and second ground plane regions also formed on that same surface.

The first and second ground plane regions of the printed circuit board 210 are separated from one another by an absorber region 220 characterized at least in part by an absence of a corresponding ground plane region. As will be described in more detail below, an absorber not explicitly shown in FIG. 2 is assumed to be deployed in the absorber region 220 to further enhance isolation between the Tx and Rx antenna arrays 202 and 204. The ground plane region is substantially removed in the absorber region 220 in order to maximize energy absorption between the Tx and Rx antenna arrays 202 and 204.

Offsetting of the Tx and Rx antenna arrays 202 and 204 relative one another as illustrated in FIG. 2 helps to provide optimum isolation across all azimuth and elevation beam steering angles. More particularly, in this embodiment, there is an approximately 22.5 degree angle between the Tx and Rx antenna arrays 202 and 204 as shown. Such an arrangement illustratively places the Rx antenna array in a substantial null of the transmit beam of the Tx antenna array for the widest possible beam steering angle ranges in elevation and azimuth. It is to be appreciated that other angles and associated relative arrangements of the Tx and Rx antenna arrays can be used in other embodiments.

The printed circuit board 210 illustratively has dimensions of about 80 mm by about 130 mm. The Tx and Rx antenna arrays each have dimensions of about 28 mm by about 28 mm, and the absorber region has a width of about 52 mm. These particular dimensions are just examples, and alternative dimensions can be used in other embodiments, and will generally vary depending on the particular operating frequencies, Tx and RX antenna arrangements and other implementation details of a particular embodiment.

In some embodiments, the gaps between the outer antenna elements of the Tx and Rx antenna arrays and adjacent edges of their corresponding ground plane region are tuned to minimize both surface waves and scattering due to diffraction. Such tuning illustratively involves adjusting a size of at least one gap between at least one outer antenna element and adjacent edges of its corresponding ground plane region until the surface waves and scattering due to diffraction are reduced or otherwise optimized for a given implementation. Examples of the tunable gaps are shown for an upper left corner antenna element of the Tx antenna array 202 in FIG. 2 by respective two-headed arrows. Other gaps between other outer antenna elements of the Tx antenna array 202 and the Rx antenna array 204 and adjacent edges of their corresponding ground plane regions can also be tuned in a similar manner. More generally, some embodiments are configured to adjust a size of at least one gap between at least one outer antenna element of a given one of the first and second sets of patch antenna elements of respective transmit and receive antenna arrays and adjacent edges of its corresponding ground plane region to reduce at least one of surface waves and scattering due to diffraction.

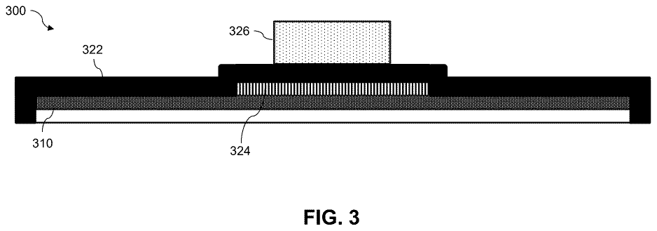

Referring now to FIG. 3, a side cross-sectional view of a radar system 300 includes a printed circuit board 310 which is illustratively configured in substantially the same manner as the printed circuit board 210 of the FIG. 2 embodiment. Accordingly, the printed circuit board 310 is assumed to comprise Tx and Rx antenna arrays that include respective first and second sets of patch antenna elements with the first and second sets arranged in opposing corners of the printed circuit board 310. The first and second sets of patch antenna elements are formed on a same surface of the printed circuit board 310, and each of the first and second sets is surrounded by a corresponding one of first and second ground plane regions also formed on that same surface. The printed circuit board 310 is mounted in a housing and covered with a radome 322. The housing and its associated mounting structures are not explicitly shown in this simplified drawing for clarity of illustration.

Additional components of the radar system 300, such as beamformers, RF transceiver circuitry, and digital processing circuitry, are also assumed to be mounted in the housing, illustratively below the printed circuit board 310, but are not explicitly shown in this figure. The radome 322 may be secured at its edges to underlying edges of the housing, again not explicitly shown. The radome 322 in the present embodiment is illustratively constructed of a low-cost plastic material, although other materials can be used in other embodiments.

In this embodiment, the radar system 300 includes both an internal absorber 324 and an external absorber 326. The first and second ground plane regions of the printed circuit board 310 are separated from one another by an absorber region characterized at least in part by an absence of a corresponding ground plane region, and the internal absorber 324 is arranged in the absorber region. For example, the internal absorber 324 can occupy substantially all of the absorber region 220 as illustrated in FIG. 2.

The internal absorber 324 is illustratively configured to attenuate surface waves traveling from the Tx antenna array to the Rx antenna array along the upper surface of the printed circuit board 310. Also, the low-cost plastic material of the radome 322 helps to prevent absorption of extended near-field energy.

The external absorber 326 is attached to an outer surface of the radome 322 in an area between the underlying first and second sets of patch antenna elements of the printed circuit board 310.

More particularly, in this illustrative embodiment, an upper surface of the radome 322 includes first and second flat portions, overlying the respective first and second sets of patch antenna elements of the printed circuit board 310, and an elevated portion between the first and second flat portions. The elevated portion of the radome 322 is configured to accommodate the underlying internal absorber 324, which is arranged in an absorber region of the printed circuit board 310 between the first and second first and second ground plane regions that surround the respective first and second sets of patch antenna elements. Also, the external absorber 326 is attached to the outer surface in the elevated portion of the radome 322.

Accordingly, the upper surface of the radome 322 illustratively includes flat portions over the Tx and Rx antenna arrays, but includes an elevated portion in the middle of the radome 322 to accommodate the underlying internal absorber 324 that is arranged between the radome 322 and the printed circuit board 310.

The external absorber 326 illustratively helps to compensate for the shape of the radome 322, which as indicated above includes an elevated portion between two flat portions. The external absorber 326 is illustratively covered with a thin, low dielectric constant, weatherproof wrapping, and is configured to absorb the near-field RF energy instead of scattering it. The external absorber 326 in such an arrangement is mounted on top of the radome 322 as shown, and utilizes the above-noted weatherproof wrapping that is essentially transparent at RF due to its thin dimension and/or low dielectric constant.

In some embodiments, the internal absorber 324 and/or the external absorber 326 comprise a dielectric foam absorber such as Eccosorb™ HIR, commercially available from Laird Technologies, Inc. For example, the external absorber 326 can comprise a dielectric foam absorber covered with the above-noted thin, low dielectric constant, weatherproof wrapping. Additional or alternative materials can be used in implementing the internal absorber 324 and the external absorber 326.

Also, although the present embodiment includes both internal absorber 324 and external absorber 326, other embodiments can be implemented with only an internal absorber, or only an external absorber.

Again, it is to be appreciated that the particular structural arrangements shown in FIGS. 2 and 3 are presented by way of example only, and should not be considered as limiting in any way.

For example, other embodiments could use a radome with a uniformly flat upper surface, eliminating the elevated portion shown in FIG. 3. Also, some embodiments can use transmit beamformer outputs of one or more antenna elements of the Tx antenna array to directly provide isolation-enhancing transmit signal cancellation at the Rx antenna array, rather than relaying on radiated transmit signals as in other embodiments.

FIG. 4 shows an example iterative calibration process implemented in a radar system in an illustrative embodiment. This example process includes steps 400 through 428, and is illustratively performed by radar system 100, although similar processes can be implemented using other radar systems disclosed herein. The process may be viewed as a calibration process implemented in a radar system comprising digital processing circuitry including at least one processor coupled to at least one memory. The process in the present embodiment iteratively identifies one or more antenna elements of the Tx antenna array that will be utilized to cancel transmit signal energy at the Rx antenna array during operation of the radar system. The process generally involves sweeping the phase of selected antenna elements of the Tx antenna array to see which one results in the best transmit signal cancellation at the Rx antenna array. This determination is done on a beam-by-beam basis, for respective different beam steering directions, and utilization of the particular antenna element or elements identified by the process for transmit signal cancellation results in a small impact to transmit signal power but a large improvement in isolation. The steps of the process are illustratively carried out under the control of such digital processing circuitry of the radar system.

In step 400, the iterative calibration process starts. As indicated previously, an iterative calibration process of the type disclosed herein can be run at various times, such as, for example, once at initialization of the radar system (e.g., during manufacturing), at any start-up of the radar system (e.g., to take into account details of the operating environment) and/or continuously (e.g., in the background, to account for changes in the environment).

In step 402, the Tx antenna array is configured to transmit at full power for a given beam. Initially, a particular one of a plurality of possible transmit beams is selected, corresponding to a particular one of a plurality of beam steering directions.

In step 404, the feed through power is read for all Rx channels. This feed through power may be viewed as a representative example of what is more generally referred to herein as amounts of transmit signal energy at the Rx antenna array. The Rx channels may correspond, for example, to respective different receive signal paths, such as first and second receive signal paths that may be provided by different receiver circuits. The different receiver circuits can include, for example, respective first and second receivers denoted Receiver 1 and Receiver 2 within the radar system, although the term “channel” as used herein is intended to be more broadly construed. For example, in some embodiments, channels may additionally or alternatively refer to different center frequencies or other types of frequency channels. Iterative calibration processes as disclosed herein can be run at multiple center frequencies or multiple other frequency channels, in addition to or in place of for different receivers.

In step 406, a determination is made as to whether or not the power is lower than a designated threshold on all Rx channels. The designated threshold is illustratively a receive signal power threshold. Responsive to an affirmative determination, the process moves to step 408, and otherwise moves to step 414 as shown.

In step 408, a determination is made as to whether or not all beams have been characterized. Responsive to an affirmative determination, the process moves to step 412, and otherwise moves to step 410 as shown.

In step 410, the beam is incremented. In other words, a different beam steering direction is selected, and the process then returns to step 402 as indicated.

In step 412, the iterative calibration process is considered complete, as the Rx channel power threshold has been met for all of the transmit beams.

In step 414, which is reached responsive to a negative determination in step 406, a subset of the patch antenna elements of the Tx antenna array is selected. In some embodiments, the subset includes only a single antenna element of the Tx antenna array, but in other embodiments multiple antenna elements can be selected.

In step 416, the phase of the selected Tx patch subset is incremented. Although phase is incremented in this embodiment, other embodiments can additionally or alternatively increment amplitude.

In step 418, the feed through power is read for all Rx channels.

In step 420, a determination is made as to whether or not the power is lower than the designated threshold on all Rx channels. Responsive to an affirmative determination, the process moves to step 410 to increment the beam, and otherwise moves to step 422 as shown.

In step 422, a determination is made as to whether or not all phases have been tried. In other words, it is determined whether or not all of the desired increments of phase have been tested, so as to provide a full sweep of the phase values for the currently-selected Tx patch subset. Responsive to an affirmative determination, the process moves to step 424, and otherwise returns to step 416 to increment the phase as indicated.

In step 424, a determination is made as to whether or not all Tx patch subsets have been tried. Responsive to an affirmative determination, the process moves to step 428, and otherwise moves to step 426 as indicated.

In step 426, the Tx patch subset is incremented, and the process returns to step 414 to select a corresponding new Tx patch subset in accordance with the current increment. In other words, a different Tx patch subset is selected for sweeping of phase values.

In step 428, which is reached responsive to an affirmative determination in step 424, the Rx gain is reduced, and the process moves to step 410 to increment the beam.

The particular steps as illustrated in the FIG. 4 process are presented by way of illustrative example only, and should not be viewed as limiting in any way. In other embodiments, additional or alternative steps may be used, and the ordering of the steps can be varied relative to the particular ordering shown in the figure. For example, certain steps shown as being performed in serial order in the figure may instead be performed at least in part in parallel with one another in other embodiments.

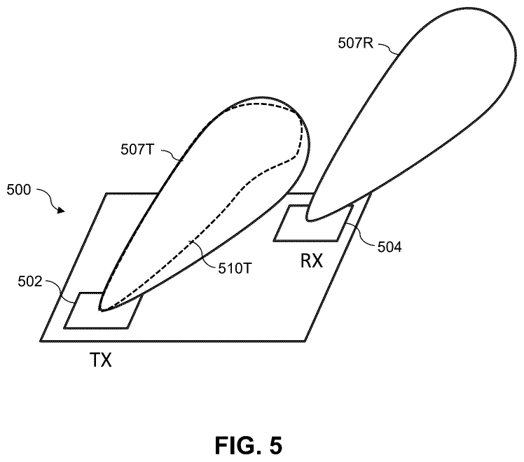

Referring now to FIG. 5, examples of antenna beams generated in illustrative embodiments are shown. In this embodiment, a radar system 500 comprises a Tx antenna array 502 and a Rx antenna array 504. The Tx and Rx antenna arrays 502 and 504 may be arranged substantially as previously described in conjunction with FIG. 2. For a given beam steering direction, the Tx antenna array generates a transmit beam 507T and the Rx antenna array generates a receive beam 507R.

It is assumed in this embodiment that a particular subset of the antenna elements of the Tx antenna array 502, illustratively a single antenna element, is identified from 16 antenna elements of a four-by-four Tx antenna array 502 as providing optimal isolation between the Tx and Rx antenna arrays 502 and 504 using the iterative calibration process of FIG. 4. This identified antenna element is then utilized for isolation-enhancing transmit signal cancellation during operation of the radar system 500. As a result of using the identified antenna element at a particular phase and amplitude selected for optimal isolation, the transmit beam 507T is altered as shown by modified transmit beam 510T. Accordingly, a small amount of distortion is introduced in the modified transmit beam 510T, with a corresponding small impact to transmit signal power, relative to the transmit beam 507T without the isolation-enhancing transmit signal cancellation, but a large improvement in isolation is achieved.

Further improvements in isolation between the Tx antenna array 502 and the Rx antenna array 504 can be achieved utilizing the internal absorber and/or external absorber as described in conjunction with FIGS. 2 and 3. Some embodiments therefore utilize an iterative calibration process as disclosed herein with the internal absorber and/or external absorber. Other embodiments can provide improved isolation using just the iterative calibration process, or just the internal and/or external absorber.

As indicated previously, radar systems as disclosed herein can generate various types of outputs, including by way of example various types of range-velocity plots, in which range is on one axis and velocity on the other, with other indicators used to illustrate one or more detected targets and their associated AOAs. For example, such a plot may be presented on a display of the radar system. A wide variety of additional or alternative outputs can be generated in a given radar system as disclosed herein.

Illustrative embodiments provide significant advantages over conventional radar systems and associated signal processing techniques.

For example, some embodiments provide a radar system with significantly improved isolation between a transmit phased array antenna and a receive phased array antenna.

In some embodiments, levels of isolation on the order of 110 dB at about 24.45 to 24.65 GHz can be achieved.

Moreover, such improved isolation can be achieved in some embodiments disclosed herein while also maintaining a minimal distance between the transmit and receive phased array antennas, thereby allowing the radar system to be implemented in a compact and low-cost configuration.

These and other advantages of illustrative embodiments disclosed herein are achieved at least in part through the use of an iterative calibration process and associated internal and/or external absorber arrangements, as described above.

Illustrative embodiments of the disclosed arrangements can be deployed in a wide variety of different use cases without limitation. These use cases can include, by way of example, detecting and tracking objects, such as objects on the ground for vehicle navigation, objects in the air for airspace monitoring, etc. As more particular examples, radar systems as disclosed herein may be deployed as automotive radars configured to provide short-range object detection, collision avoidance and driver assistance, and/or as airspace radars configured to provide air traffic monitoring, support for military/defense applications, etc. Again, numerous other deployments of the disclosed radar systems are possible.

The above-noted features and advantages of illustrative embodiments may or may not be present in other embodiments.

One or more radar systems or associated information processing systems as disclosed herein can be implemented using one or more processing platforms each comprising at least one processing device, where a given such processing device may comprise a computer, server or other processing device, or combinations of multiple processing devices. Such computers, servers or other processing devices each illustratively comprise at least one processor coupled to a memory. For example, the radar system 100, and possibly also one or more external devices or systems in communication therewith, may be implemented utilizing one or more such processing platforms, each comprising one or more processing devices. Terms such as “processing platform” as used herein are intended to be broadly construed.

The above-noted processing platforms can each include multiple processing devices.

Examples of such processing devices include computers or servers comprising respective processors and associated memory, or other types of processing devices. Storage devices such as storage arrays or cloud-based storage systems used for storing data herein are also considered “processing devices” as that term is broadly used herein.

The processing devices can be configured to communicate over one or more networks. The one or more networks can comprise, for example, a global computer network such as the Internet, a WAN, a LAN, a satellite network, a telephone or cable network, a cellular network such as a 4G or 5G network, a wireless network implemented using a wireless protocol such as Bluetooth, WiFi or WiMAX, or various portions or combinations of these and other types of communication networks.

A processing platform in some embodiments comprises at least one processor, at least one memory and at least one network interface. The processor is assumed to be operatively coupled to the memory and to the network interface. The term “processor” as used herein is therefore intended to be broadly construed.

The processor in some embodiments may comprise, for example, a microprocessor, an FPGA, a central processing unit (CPU), a graphics processing unit (GPU), an application-specific integrated circuit (ASIC), a system-on-chip (SOC), a neural processing unit (NPU), a data processing unit (DPU), a tensor processing unit (TPU), an arithmetic logic unit (ALU), a digital signal processor (DSP), and/or another processing device component, or combinations of multiple such components, as well as other types and arrangements of processing circuitry in any combination.

At least a portion of the functionality of a radar system as disclosed herein can be implemented using such circuitry.

In some embodiments, the processor comprises one or more graphics processor integrated circuits. Such graphics processor integrated circuits are illustratively implemented in the form of one or more GPUs. Accordingly, in some embodiments, radar system 100 is configured to include a GPU-based processing platform. Such a GPU-based processing platform can be at least partially cloud-based and is illustratively configured to implement one or more machine learning systems in conjunction with the timing synchronization functionality disclosed herein. Similar arrangements can be implemented using one or more CPUs, NPUs, DPUs, TPUs and/or other processing devices, in any combination.

A memory illustratively stores software program code for execution by a corresponding processor in implementing portions of the functionality of the processing platform. For example, at least portions of the functionality of a radar system as disclosed herein can be implemented using program code stored in one or more memories of one or more processing devices.

A given such memory that stores such program code for execution by a corresponding processor is an example of what is more generally referred to herein as a processor-readable storage medium having program code embodied therein, and may comprise, for example, electronic memory such as SRAM, DRAM or other types of random access memory, flash memory, read-only memory (ROM), magnetic memory, optical memory, or other types of storage devices in any combination.

Articles of manufacture comprising such processor-readable storage media are considered embodiments of the present disclosure. The term “article of manufacture” as used herein should be understood to exclude transitory, propagating signals.

Other types of computer program products comprising processor-readable storage media can be implemented in other embodiments.

In addition, illustrative embodiments may be implemented in the form of integrated circuits comprising processing circuitry configured to implement processing operations associated with a radar system as disclosed herein, as well as other related functionality. For example, at least a portion of the functionality of a given such radar system is illustratively implemented in at least one integrated circuit of a processing device of a processing platform.

The network interface is configured to allow the processing platform to communicate over one or more networks with other system elements, and may comprise one or more conventional transceivers.

It is to be appreciated that the particular arrangements of components and other system elements shown in FIGS. 1 through 5 are presented by way of illustrative example only, and numerous alternative embodiments are possible. For example, other embodiments of radar systems and associated information processing systems can be configured to implement signal processing functionality of the type disclosed herein.

Accordingly, although illustrative embodiments are described in the context of particular radar system configurations, it is to be appreciated that the disclosed techniques can be adapted in a straightforward manner to a wide variety of other radar system configurations.

Also, information processing systems with radar system functionality as disclosed herein can be configured to support a wide variety of distinct applications, in numerous diverse contexts. References herein to particular applications, such as multi-modal sensor systems with radars and implemented utilizing drones or other aerial or terrestrial vehicles, are therefore presented by way of illustrative example only, and the disclosed techniques can be adapted for use in any of a wide variety of other contexts.

The various embodiments disclosed herein should therefore not be construed as limiting in any way. Numerous alternative configurations of radar systems and associated signal processing operations can be utilized in other embodiments.

An information processing system incorporating or otherwise utilizing radar system functionality as disclosed herein may be implemented using one or more processing platforms, or portions thereof.

For example, one illustrative embodiment of a processing platform that may be used to implement at least a portion of an information processing system comprises cloud infrastructure including virtual machines implemented using a hypervisor that runs on physical infrastructure.

Such virtual machines may comprise respective processing devices that communicate with one another over one or more networks.

The cloud infrastructure in such an embodiment may further comprise one or more sets of applications running on respective ones of the virtual machines under the control of the hypervisor. It is also possible to use multiple hypervisors each providing a set of virtual machines using at least one underlying physical machine. Different sets of virtual machines provided by one or more hypervisors may be utilized in configuring multiple instances of various components of the information processing system.

Another illustrative embodiment of a processing platform that may be used to implement at least a portion of an information processing system as disclosed herein comprises a plurality of processing devices which communicate with one another over at least one network. Each processing device of the processing platform is assumed to comprise a processor coupled to a memory.

Again, these particular processing platforms are presented by way of example only, and an information processing system may include additional or alternative processing platforms, as well as numerous distinct processing platforms in any combination, with each such platform comprising one or more computers, storage devices or other processing devices.

A given processing platform implementing at least a portion of a radar system and/or an associated information processing system as disclosed herein can run on or be otherwise supported by cloud infrastructure or other types of virtualization infrastructure.

It should therefore be understood that in other embodiments different arrangements of additional or alternative elements may be used. At least a subset of these elements may be collectively implemented on a common processing platform, or each such element may be implemented on a separate processing platform.

Also, numerous other arrangements of computers, servers, storage devices or other components are possible in an information processing system. Such components can communicate with other elements of the information processing system over any type of network or other communication media.

As indicated previously, components of the system as disclosed herein can be implemented at least in part in the form of one or more software programs stored in memory and executed by a processor of a processing device. For example, certain functionality disclosed herein can be implemented at least in part in the form of software.

The particular configurations of information processing systems described herein are exemplary only, and a given such system in other embodiments may include other elements in addition to or in place of those specifically shown, including one or more elements of a type commonly found in a conventional implementation of such a system.

For example, in some embodiments, an information processing system may be configured to utilize the disclosed techniques to provide additional or alternative functionality in other contexts.

It should again be emphasized that the embodiments of the present disclosure as described herein are intended to be illustrative only. Other embodiments of the present disclosure can be implemented utilizing a wide variety of different types and arrangements of radar systems and associated information processing systems and/or other devices and systems, and corresponding signal processing operations, than those utilized in the particular illustrative embodiments described herein, and in numerous alternative radar system contexts. In addition, the particular assumptions made herein in the context of describing certain embodiments need not apply in other embodiments. These and numerous other alternative embodiments will be readily apparent to those skilled in the art.

What is claimed is:

1. A method comprising:
performing an iterative calibration process in which transmit signals are transmitted via respective different selected subsets of antenna elements of a transmit phased array antenna of a radar system and corresponding amounts of transmit signal energy are monitored in a receive phased array antenna of the radar system to determine impacts of the different selected subsets of antenna elements of the transmit phased array antenna on isolation between the transmit and receive phased array antennas;
identifying a particular one of the different selected subsets of the antenna elements of the transmit phased array antenna based at least in part on their relative impacts on the isolation between the transmit and receive phased array antennas; and
utilizing the particular identified subset of the antenna elements of the transmit phased array antenna for isolation-enhancing transmit signal cancellation during operation of the radar system.

2. The method of claim 1 wherein the transmit and receive phased array antennas comprise respective planar arrays of patch antenna elements.

3. The method of claim 1 wherein one or more of the different selected subsets each comprise only a single antenna element of the transmit phased array antenna.

4. The method of claim 1 wherein utilizing the particular identified subset of the antenna elements of the transmit phased array antenna for isolation-enhancing signal cancellation during operation of the radar system comprises transmitting a transmit signal via the particular identified subset of the antenna elements at particular phase and amplitude values determined as part of the iterative calibration process.

5. The method of claim 4 wherein the particular phase and amplitude values comprise phase and amplitude values identified by adjusting the isolation between the transmit and receive phased array antennas during the iterative calibration process until a receive signal power threshold is met.

6. The method of claim 1 the transmit and receive phased array antennas each comprise a same number and arrangement of antenna elements.

7. The method of claim 1 wherein at least one of the transmit and receive phased array antennas comprises a square array of antenna elements.

8. The method of claim 7 wherein at least one of the transmit and receive phased array antennas comprises a four-by-four array of antenna elements.

9. The method of claim 1 wherein the transmit and receive phased array antennas are separated from one another by at least one absorber configured to further enhance isolation between the transmit and receive phased array antennas.

10. The method of claim 1 wherein the transmit and receive phased array antennas comprise respective first and second sets of patch antenna elements with the first and second sets arranged in opposing corners of a printed circuit board.

11. The method of claim 10 wherein first and second sets of patch antenna elements are formed on a same surface of the printed circuit board and each of the first and second sets is surrounded by a corresponding one of first and second ground plane regions also formed on that same surface.

12. The method of claim 11 wherein the first and second ground plane regions are separated from one another by an absorber region characterized at least in part by an absence of a corresponding ground plane region, and further wherein an absorber is deployed in the absorber region to further enhance isolation between the transmit and receive phased array antennas.

13. The method of claim 10 wherein the printed circuit board is mounted in a housing and covered with a radome, and further wherein an external absorber is attached to an outer surface of the radome in an area between the first and second sets of patch antenna elements of the printed circuit board.

14. The method of claim 13 wherein the radome includes first and second flat portions, overlying the respective first and second sets of patch antenna elements of the printed circuit board, and an elevated portion between the first and second flat portions, the elevated portion being configured to accommodate an underlying internal absorber, and further wherein the external absorber is attached to the outer surface in the elevated portion of the radome.

15. The method of claim 1 wherein the iterative calibration process is configured to iterate in an outer loop over a plurality of beam steering directions of the transmit phased array antenna and to iterate in an inner loop over the different selected subsets of the antenna elements of the transmit phased array antenna for each of the plurality of beam steering directions of the outer loop.

16. The method of claim 15 wherein for a given one of the iterations of the inner loop, at least one of phase and amplitude values of the transmit signal transmitted by a corresponding one of the different selected subsets of the antenna elements are incrementally varied as corresponding amounts of transmit signal energy are monitored in the receive phased array antenna of the radar system.

17. The method of claim 15 wherein the identifying and utilizing are separately performed for each of one or more of the plurality of beam steering directions iterated in the outer loop.

18. The method of claim 1 wherein the iterative calibration process is performed at least one of:
in conjunction with an initialization of the radar system;
at each of a plurality of different start-ups of the radar system; and
as a substantially continuous background process.

19. The method of claim 11 further comprising adjusting a size of at least one gap between at least one outer antenna element of a given one of the first and second sets of patch antenna elements and adjacent edges of its corresponding ground plane region to reduce at least one of surface waves and scattering due to diffraction.

20. A radar system comprising:
a transmit phased array antenna;
a receive phased array antenna; and
at least one processing device coupled to the transmit and receive phased array antennas, wherein the at least one processing device is configured:
to perform an iterative calibration process in which transmit signals are transmitted via respective different selected subsets of antenna elements of a transmit phased array antenna of a radar system and corresponding amounts of transmit signal energy are monitored in a receive phased array antenna of the radar system to determine impacts of the different selected subsets of antenna elements of the transmit phased array antenna on isolation between the transmit and receive phased array antennas;
to identify a particular one of the different selected subsets of the antenna elements of the transmit phased array antenna based at least in part on their relative impacts on the isolation between the transmit and receive phased array antennas; and
to utilize the particular identified subset of the antenna elements of the transmit phased array antenna for isolation-enhancing transmit signal cancellation during operation of the radar system.

21. A computer program product comprising a non-transitory processor-readable storage medium having stored therein program code of one or more software programs of a radar system, the radar system comprising a transmit phased array antenna and a receive phased array antenna, wherein the program code, when executed by at least one processing device of the radar system, causes the radar system:
to perform an iterative calibration process in which transmit signals are transmitted via respective different selected subsets of antenna elements of a transmit phased array antenna of a radar system and corresponding amounts of transmit signal energy are monitored in a receive phased array antenna of the radar system to determine impacts of the different selected subsets of antenna elements of the transmit phased array antenna on isolation between the transmit and receive phased array antennas;
to identify a particular one of the different selected subsets of the antenna elements of the transmit phased array antenna based at least in part on their relative impacts on the isolation between the transmit and receive phased array antennas; and
to utilize the particular identified subset of the antenna elements of the transmit phased array antenna for isolation-enhancing transmit signal cancellation during operation of the radar system.
